(19) United States
(12) Patent Application Publication
(10) Pub. No.: US 2014/0267264 A1
(43) Pub. Date: Sep. 18, 2014

(54) GENERATING ANTI-ALIASED VOXEL DATA

(71) Applicant: NVIDIA CORPORATION, Santa Clara, CA (US)

(72) Inventors: Cyril CRASSIN, Paris (FR); Yury Y. URALSKY, Moscow (RU); Eric ENDERTON, Berkeley, CA (US); Eric B. LUM, San Jose, CA (US); Jerome F. DULUK, JR., Palo Alto, CA (US); Henry Packard MORETON, Woodside, CA (US); David LUEBKE, Charlottesville, VA (US)

(73) Assignee: NVIDIA CORPORATION, Santa Clara, CA (US)

(21) Appl. No.: 13/830,106

(22) Filed: Mar. 14, 2013

(51) Int. Cl. G06T 15/08

(52) U.S. Cl. CPC G06T 15/08
USPC 345/424

(57) ABSTRACT

One embodiment of the present invention sets forth a technique for performing voxelization. The technique involves identifying a voxel that is intersected by a first graphics primitive that has a front side and a back side and selecting a plurality of sample points within the voxel. The technique further involves determining, for each sample point included in the plurality of sample points, whether the sample point is located on the front side of the first graphics primitive or on the back side of the first graphics primitive. Finally, the technique involves storing, for at least a first sample point included in the plurality of sample points, a first result in a voxel mask reflecting whether the first sample point is located on the front side of the first graphics primitive or on the back side of the first graphics primitive.

### BACKGROUND OF THE INVENTION

1. Field of the Invention

The present invention generally relates to computer graphics and, more specifically, to generating anti-aliased voxel data.

2. Description of the Related Art

Voxelization is a technique in which geometric objects (e.g., triangle meshes) are converted into volumetric picture elements known as voxels. The process of voxelization may be compared to the process of rasterization, in which geometric objects are projected onto a view-plane and assigned to one or more pixel locations. However, whereas a pixel represents a two-dimensional portion of a view-plane, a voxel represents a cube-like volume within a three-dimensional scene. Thus, instead of simply determining which pixel(s) each geometric object covers, the process of voxelization determines which volumetric elements each geometric object intersects. Once constructed, a voxelized representation of a three-dimensional scene may be used for a number of subsequent computations, including computations for lighting (e.g. global illumination), fluid dynamics with object boundaries, and collision detection for physics simulations, to name a few.

Conventional graphics processing systems usually perform voxelization in a binary manner. That is, conventional systems determine that a voxel is either ‘occupied’—if the voxel is intersected by a geometric object—or ‘not occupied’—if the voxel is not intersected by the geometric object. This type of binary approximation causes various problems with three-dimensional graphics and modeling. For example, when constructing a voxelized representation of a scene that includes moving objects, an object may move from not occupying a voxel in one frame to fully occupying the voxel in the next frame. This abrupt change causes voxels to “pop” into and out of occupancy as geometric objects move with respect to the scene (e.g., as an object traverses a scene). Similarly, imprecision introduced by the above binary approximation can negatively impact many types of subsequent computations performed using the voxelized representation. For example, rounding errors introduced by the above binary approximation can cause computational inaccuracies when performing downstream lighting computations, collision detection analyses, or fluid dynamic calculations, to name a few.

Accordingly, what is needed in the art is a more effective approach to voxelizing geometric objects.

### SUMMARY OF THE INVENTION

One embodiment of the present invention sets forth a method for performing voxelization. The method involves identifying a voxel that is intersected by a first graphics primitive that has a front side and a back side and selecting a plurality of sample points within the voxel. The method further involves determining, for each sample point included in the plurality of sample points, whether the sample point is located on the front side of the first graphics primitive or on the back side of the first graphics primitive. Finally, the method involves storing, for at least a first sample point included in the plurality of sample points, a first result in a voxel mask reflecting whether the first sample point is located on the front side of the first graphics primitive or on the back side of the first graphics primitive

Further embodiments provide a non-transitory computer-readable medium and a computing device to carry out the method set forth above.

One advantage of the disclosed techniques is that a voxelized representation of a geometric object can be efficiently constructed and used to determine fractional occupancy and/or occlusion values. The determined occupancy and/or occlusion values then can be used to perform subsequent graphics operations or modeling computations without introducing as many artifacts and inaccuracies as conventional voxelization approaches. Further, the voxel masks, surface equations, and scalar fields described herein provide varying levels of accuracy, precision, and processing workload that can be selected and utilized to construct voxelized representations of geometric objects for a wide variety of applications.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a parallel processing subsystem, according to one embodiment of the present invention;

FIG. 3 is a block diagram of a GPC within one of the PPUs of FIG. 2, according to one embodiment of the present invention;

FIG. 4 is a conceptual diagram of a graphics processing pipeline that one or more of the PPUs of FIG. 2 can be configured to implement, according to one embodiment of the present invention;

FIG. 5 illustrates the voxelization of a graphics primitive in a three-dimensional scene, according to one embodiment of the present invention;

FIGS. 6A and 6B illustrate a technique for performing multi-sample anti-aliased (MSAA) voxelization, according to one embodiment of the present invention;

FIG. 7A is a flow diagram of method steps for performing MSAA voxelization, according to one embodiment of the present invention;

FIG. 7B is a flow diagram of method steps for analyzing sample points distributed within a voxel, according to one embodiment of the present invention;

FIGS. 8A and 8B illustrate a technique for performing voxelization using surface equations, according to one embodiment of the present invention;

FIG. 9 is a flow diagram of method steps for performing voxelization using surface equations, according to one embodiment of the present invention;

FIGS. 10A and 10B illustrate a technique for performing voxelization using scalar fields, according to one embodiment of the present invention; and

FIG. 11 is a flow diagram of method steps for performing voxelization using scalar fields, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. The system memory 104 may be configured to store a device driver 103. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system-on-chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), memory devices, or in any other technically feasible fashion.

Referring again to FIG. 1 as well as FIG. 2, in some embodiments, some or all of PPUs 202 in parallel processing subsystem 112 are graphics processors with rendering pipelines that can be configured to perform various operations related to generating pixel data from graphics data (e.g., geometric objects) supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D≧1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, calculating surface equations (e.g., plane equations, quadric surface equations, etc.), and/or distances to a surface, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory 104 exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, smart phones, servers, workstations, game consoles, embedded systems, and the like.

FIG. 3 is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons of ordinary skill in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

In one embodiment, each GPC 208 includes a number M of SMs 310, where M≧1, each SM 310 configured to process one or more thread groups. Also, each SM 310 advantageously includes an identical set of functional execution units (e.g., execution units and load-store units) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional unit hardware can be leveraged to perform different operations, including performing voxelization operations (e.g., intersection and projection calculations, sample point testing, distance and volume computations, table lookups, etc.).

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains a level one (L1) cache or uses space in a corresponding L1 cache outside of the SM 310 that is used to perform load and store operations. Each SM 310 also has access to level two (L2) caches that are shared among all GPCs 208 and may be used to transfer data between threads. Finally, SMs 310 also have access to off-chip “global” memory, which can include, e.g., parallel processing memory 204 and/or system memory 104. It is to be understood that any memory external to PPU 202 may be used as global memory. Additionally, a level one-point-five (L1.5) cache 335 may be included within the GPC 208, configured to receive and hold data fetched from memory via memory interface 214 requested by SM 310, including instructions, uniform data, and constant data, and provide the requested data to SM 310. Embodiments having multiple SMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units 215. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache that is shared between all GPCs 208, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, as shown in FIG. 2, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches to execute tasks for one or more application programs.

Persons of ordinary skill in the art will understand that the architecture described in FIGS. 1, 2 and 3 in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during the thread's execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CIA” and “thread array” are used synonymously herein.

### Graphics Pipeline Architecture

FIG. 4 is a conceptual diagram of a graphics processing pipeline 400, that one or more of the PPUs 202 of FIG. 2 can be configured to implement, according to one embodiment of the present invention. For example, one of the GPCs 208 may be configured to perform the functions of one or more of a vertex processing unit 415, a geometry processing unit 425, and a fragment processing unit 460. The functions of data assembler 410, primitive assembler 420, rasterizer 455, and raster operations unit 465 may also be performed by other processing engines within a GPC 208 and a corresponding partition unit 215. Alternately, graphics processing pipeline 400 may be implemented using dedicated processing units for one or more functions.

Data assembler 410 collects vertex data for high-order surfaces, primitives, and the like, and outputs the vertex data, including the vertex attributes, to vertex processing unit 415. Vertex processing unit 415 is a programmable execution unit that is configured to execute vertex shader programs, lighting and transforming vertex data as specified by the vertex shader programs. For example, vertex processing unit 415 may be programmed to transform the vertex data from an object-based coordinate representation (object space) to an alternatively based coordinate system such as world space or normalized device coordinates (NDC) space. Vertex processing unit 415 may read data that is stored in a GPC 208 cache, parallel processing memory 204, or system memory 104 by data assembler 410 for use in processing the vertex data.

Primitive assembler 420 receives vertex attributes from vertex processing unit 415, reading stored vertex attributes, as needed, and constructs graphics primitives for processing by geometry processing unit 425. Graphics primitives include triangles, line segments, points, and the like. Geometry processing unit 425 is a programmable execution unit that is configured to execute geometry shader programs, transforming graphics primitives received from primitive assembler 420 as specified by the geometry shader programs. Additionally, the geometry processing unit 425 may be programmed to calculate parameters, such as plane equation coefficients, that are used to rasterize the new graphics primitives, calculate voxel intersections, perform projection calculations, compute curvature values, and perform other types of voxelization operations.

In some embodiments, geometry processing unit 425 may also add or delete elements in the geometry stream. Geometry processing unit 425 outputs the parameters and vertices specifying new graphics primitives to a viewport scale, cull, and clip unit 450. Geometry processing unit 425 may read data that is stored in parallel processing memory 204 or system memory 104 for use in processing the geometry data. Viewport scale, cull, and clip unit 450 performs clipping (e.g., clipping a plane or surface to a voxel), culling, and viewport scaling and outputs processed graphics primitives to a rasterizer 455.

Rasterizer 455 scan converts the new graphics primitives and outputs fragments and coverage data to fragment processing unit 460. The rasterizer 455 may perform rasterization in two dimensions and/or three dimensions to generate two-dimensional and/or three-dimensional coverage data. Two-dimensional coverage may be generated by the rasterizer 455 using an anti-aliasing unit (e.g., multi-sampling anti-aliasing (MSAA) hardware). Three-dimensional coverage may be stored in a voxel mask. Additionally, rasterizer 455 may be configured to perform z culling, depth-testing, and other z-based optimizations. For example, rasterizer 455 may be configured to determine the coverage of a graphics primitive with respect to one or more sample points and/or the depth of the one or more sample points with respect to the graphics primitive.

Fragment processing unit 460 is a programmable execution unit that is configured to execute fragment shader programs, transforming fragments received from rasterizer 455, as specified by the fragment shader programs. For example, fragment processing unit 460 may be programmed to perform operations such as perspective correction, texture mapping, shading, blending, and the like, to produce shaded fragments that are output to raster operations unit 465. Fragment processing unit 460 may read data that is stored in parallel processing memory 204 or system memory 104 for use in processing the fragment data. Fragments may be shaded at pixel, sample, or other granularity, depending on the programmed sampling rate.

Raster operations unit 465 is a processing unit that performs raster operations, such as stencil, z test, blending, and the like, and outputs pixel data as processed graphics data for storage in graphics memory. The processed graphics data may be stored in graphics memory, e.g., parallel processing memory 204, and/or system memory 104, for display on display device 110 or for further processing by CPU 102 or parallel processing subsystem 112. In some embodiments of the present invention, raster operations unit 465 is configured to compress z or color data that is written to memory and decompress z or color data that is read from memory.

### Generating Anti-Aliased Voxel Data

FIG. 5 illustrates the voxelization of a graphics primitive 520 in a three-dimensional scene 500, according to one embodiment of the present invention. As shown in FIG. 5, each voxel 510 represents a cube-like volume in the scene 500. Each intersection between the primitive 520 and a voxel 510 may define a three-dimensional voxel fragment, sometimes referred to herein as a “fragment.”

The primitive 520 may be part of a larger geometric object, such as a triangle mesh representation of a three-dimensional object within the three-dimensional scene 500. Accordingly, the primitive 520 may include a front face and a back face. In various embodiments, the front face of the primitive 520 is defined as the surface which faces outside of the geometric object, and the back face is defined as the surface which faces an interior volume of the geometric object. The direction of the front face and back face of the primitive 520 may be indicated by the surface normal of the primitive 520 and/or by the order in which the vertices of a primitive 520 are specified. For example, the front face of the primitive 520 may be indicated by the direction of its surface normal, which may be determined by the order (e.g., clockwise or counterclockwise) in which the vertices 525 of the primitive 520 are specified.

Although the following techniques are described as being performed with specific hardware units (e.g., the geometry processing unit 425, rasterizer 455, fragment processing unit 460, raster operations unit 465, etc.), each technique described below may be performed in an equivalent manner using software, dedicated hardware, or a combination thereof. For example, techniques described as being performed using the rasterizer 455 (e.g., generating a coverage mask) could be performed in an equivalent manner using software (e.g., with the fragment processing unit 460). Additionally, techniques described as being performed using software may instead be performed using dedicated hardware. Furthermore, although the following techniques are described as using sample points, each technique described herein may be performed using any type(s) of reference points or reference locations (e.g., voxel corner(s), voxel edge(s), voxel face(s), a center point, off-center point(s), etc.).

FIGS. 6A and 6B illustrate a technique for performing multi-sample anti-aliased (MSAA) voxelization, according to one embodiment of the present invention. MSAA voxelization may be performed by analyzing each sample point 610 (e.g., 610-1) within the voxel 510-1 to determine whether the sample point 610 is on the front side 635 or the back side 630 of a primitive 520-1. The results of this analysis may be stored in a voxel mask and used to compute fractional occupancy and/or occlusion (e.g., to what degree the voxel 510-1 blocks light in one or more directions) values for the voxel 510-1. For example, fractional occupancy may be estimated as the fraction of sample points 610 that are inside of a geometric object to which the primitive 520-1 belongs (e.g., the fraction of sample points 610 on the back side 630 of the primitive 520-1). Occlusion values may be estimated by projecting the three-dimensional coverage (e.g., stored in the voxel mask) onto one or more planes. After computing fractional occupancy and/or occlusion values, these values may then be used to perform downstream computations, such as lighting, fluid dynamics, and collision detection computations. Exemplary techniques for performing MSAA voxelization are described below in further detail with respect to FIGS. 7A and 7B.

FIG. 7A is a flow diagram of method steps for performing MSAA voxelization, according to one embodiment of the present invention. Although the method steps are described in conjunction with the systems of FIGS. 1-4, persons skilled in the art will understand that any system configured to perform the method steps, in any order, falls within the scope of the present invention.

As shown, a method 700 begins at step 710, where the geometry processing unit 425 determines that a voxel 510-1 is intersected by one or more primitives 520. At step 715, the geometry processing unit 425 selects a primitive 520-1 that intersects the voxel 510-1, as shown in FIGS. 6A and 6B.

Next, at step 720, a plurality of sample points 610 (e.g., 610-1) are distributed within the voxel 510-1. In addition to the sample point distribution illustrated in FIGS. 6A and 6B, distributing sample points 610 within the voxel 510-1 may include distributing sample points 610 on one or more edges and/or corners of the voxel 510-1. Sample points 610 may be arranged on a regular lattice such that their projection onto each of the three major planes (e.g., x, y, and z planes) results in the same pattern, as illustrated in FIGS. 6A and 6B. However, embodiments of the present invention also contemplate that any regular or irregular pattern or grid of sample points 610 may be used.

Any number of sample points 610 may be distributed within the voxel 510-1. The number of sample points 610 may be based on, for example, a desired granularity, accuracy, processing workload, etc. In one embodiment, 64 sample points 610 (e.g., 4×4×4 sample points) may be distributed in the voxel 510-1 such that the computed occupancy of the voxel is quantized to 1/64. Selecting too few sample points 610 may result in “popping” when voxelizing small animated objects, such as objects having small, sharp features. On the other hand, selecting too many sample points 610 may increase processing requirements above a desired level.

At step 725, the rasterizer 455 (and/or the fragment processing unit 460) analyzes each sample point 610 to determine whether the sample point 610 is on a front side 635 or a back side 630 of the primitive 520-1. As discussed above, whether a sample point is on the front side 635 or the back side 630 of a primitive 520 may indicate whether the sample point is outside or inside of a geometric object (e.g., triangle mesh) to which the primitive 520 belongs. This analysis may be performed using a variety of techniques. Two exemplary techniques are described below.

In a first technique, the rasterizer 455 (and/or the fragment processing unit 460) evaluates each sample point 610 against a plane (or surface) equation to determine whether the sample point 610 is on a front side 635 or a back side 630 of the plane. The results of the analysis may be stored in a voxel mask, for example, by setting a mask bit for each sample point 610 on a back side 630 (or front side 635) of the plane. The plane equation against which each sample point 610 is evaluated may be based on the coordinates of the vertices of the primitive 520-1 and/or derived from the intersection of the primitive 520-1 with the voxel 510-1. For example, the plane equation may be acquired by clipping the primitive 520-1 to the voxel 510-1 to determine an equation for a clipped plane 620. Additionally, the plane equation against which each sample point 610 is evaluated may be an aggregate plane (or higher-order surface) equation calculated by averaging or otherwise aggregating the intersections of multiple primitives 520.

In a second technique for analyzing the sample points 610, the primitive 520-1 is projected onto a two-dimensional plane of sample points 610, and the rasterizer 455 (and/or the fragment processing unit 460) determines coverage for the plane of sample points 610. The sample points 610 disposed in, or otherwise associated with, the two-dimensional plane include only a portion of the total number of sample points 610 distributed within the voxel 510-1. For example, if a 4×4×4 grid of samples points 610 is distributed within the voxel 510-1, then a two dimensional plane of sample points may include a 4×4 plane of sample points 610 (i.e., 16 sample points). After determining coverage for the plane of sample points 610, the rasterizer 455 performs depth-testing of the column sample points 610 above and/or below each covered sample point 610 to determine whether each sample point 610 is on the front side 635 or the back side 630 of the primitive 520-1. Depth-testing is not performed for column(s) of sample points 610 above and/or below each uncovered sample point 610. One embodiment of this technique is illustrated with respect to FIG. 7B.

FIG. 7B is a flow diagram of method steps for analyzing sample points 610 distributed within a voxel 510, according to one embodiment of the present invention. Although the method steps are described in conjunction with the systems of FIGS. 1-4, persons skilled in the art will understand that any system configured to perform the method steps, in any order, falls within the scope of the present invention.

As shown, a method 702 begins at step 750 where the rasterizer 455 (and/or the fragment processing unit 460) selects a plane onto which the primitive 520-1 is to be projected. In order to maximize the projected area of the primitive 520-1 (e.g., to increase the likelihood that coverage is properly computed for all samples covered by the primitive 520-1), the selected plane may be a plane perpendicular to the dominant axis of the surface normal 640 of the primitive 520-1. The dominant axis may be one of the major axes (e.g., the x, y, or z axes). In other embodiments, the plane onto which the primitive 520-1 is projected may be a plane which intersects a desired number of sample points 610 or a plane having an orientation which permits effective analysis of a given pattern or grid of sample points 610. At step 755, the rasterizer 455 projects the primitive 520-1 onto the selected plane. At step 760, the rasterizer 455 determines coverage of the projection of the primitive 520-1 for each sample point 610 in, or associated with, the selected plane.

Next, at step 765, the rasterizer 455 selects a covered sample point 610, and, at step 770, a column of sample points 610 extending above and/or below the covered sample point 610 is defined. Each sample point 610 in the column of sample points 610 is then analyzed by the rasterizer 455 at step 775 (e.g., by depth-testing) to determine whether the sample point 610 is on the front side 635 or the back side 630 of the primitive 520-1. At step 780, the rasterizer 455 stores the results of the analysis in a voxel mask, for example, by setting a bit for each sample point 610 determined to be on the back side 630 (or front side 635) of the primitive 520-1. Finally, at step 785, the rasterizer 455 selects another covered sample point 610, if necessary, and the analysis process repeats at step 765.

Advantageously, the second technique for analyzing sample points 610 may reduce the number of sample points 610 that are analyzed. For example, if the rasterizer 455 determines (at step 760) that one or more sample points 610 are not covered by the projection of the primitive 520-1, then no further analysis may be performed on the column(s) of sample points 610 above and/or below the uncovered sample point(s) 610.

After each sample point 610 is analyzed, a determination is made at step 730 regarding whether results were previously stored for the voxel 510-1. For example, results could previously have been stored for the voxel 510-1 if one or more other primitives 520 intersect the voxel 510-1 and were previously analyzed. If no results were stored for the voxel 510-1, then the results computed in step 725 are stored in the voxel mask at step 735. If results were previously stored for the voxel 510-1, then the fragment processing unit 460 (or raster operations unit 465) may combine the results computed in step 725 with the stored results at step 737, for example, by using a Boolean operator (e.g., OR, AND, NOT, etc.). For example, if a bit was set for a sample point 610 in either the results determined in step 725 OR the results previously stored in the voxel mask, then a bit could be set for the sample point 610 in the stored voxel mask. At step 740, if another primitive 520 intersects the voxel 510-1, then the primitive 520 may be selected and analyzed beginning at step 715, and the results may be combined with the voxel mask at step 737.

Finally, at step 745, once coverage is computed and stored (e.g., in a voxel mask) for the voxel 510-1, the fragment processing unit 460 may use the results to determine which direction(s) the face(s) of the voxel 510-1 is/are pointed and/or the curvature of the surface of the voxel 510-1. Curvature may be determined, for example, when the edges of two or more primitives 520 meet within a voxel 510. Additionally, coverage results may be used to determine the fraction of the voxel 510-1 intersected by the primitive(s) 520 (i.e., the fraction of the voxel 510-1 on the front side 635 or back side 630 of the primitive(s) 520) and/or the fraction of the voxel 510-1 occupied (i.e., fractional occupancy) by the geometric object(s) to which the primitive(s) 520 belong. In one embodiment, fractional occupancy of the voxel may be determined by the fraction of bits which have been set in the voxel mask. For example, if 64 sample points are distributed within the voxel 510-1, and bits in the voxel mask corresponding to 16 different samples points 610 have been set, then the fractional occupancy of the voxel is 16/64, or ¼.

The fragment processing unit 460 may further use the voxel mask to compute occlusion values (e.g., directional occlusion, ambient occlusion, and the like). For example, directional occlusion values may be computed by projecting the three-dimensional coverage, as indicated by the voxel mask, onto one or more planes. In one embodiment, the coverage values may be projected along the three major axes onto three planes, and three two-dimensional masks may be stored for the voxel 510-1. Directional occlusion then may be computed for a given vector by interpolating the two-dimensional masks according to the magnitude of the vector in each of the three major axes. In other embodiments, instead of storing the results computed at step 725 in a voxel mask, the results may be stored in three two-dimensional masks (e.g., to increase memory efficiency). A two-dimensional mask may be stored for each of the three major axes. The fragment processing unit 460 may then use the two-dimensional masks to compute occlusion values, as described above.

When the number of sample points 610 per voxel 510 is high, storing three projected two-dimensional masks, as opposed to one three-dimensional mask, may reduce the amount of memory needed. More specifically, whereas the number of sample points 610 in a three-dimensional mask increases with the cube of the sample point 610 resolution, the number of sample points 610 in three two-dimensional masks grows with the square of the sample point 610 resolution.

FIGS. 8A and 8B illustrate a technique for performing voxelization using surface equations, according to one embodiment of the present invention. This particular voxelization technique may be performed by calculating a surface equation based on one or more primitives 520 (e.g., 520-2) which intersect a voxel 510. The surface equation may be calculated by accumulating plane equations, for example, by aggregating the plane coefficients of each primitive 520 which intersects a voxel 510. The surface equation may include a plane equation (e.g., an average normal and an average distance from a reference point in the voxel 510), or the surface equation may include a higher-order equation (e.g., a quadric surface) to more accurately represent the characteristics (e.g., curvature) of a plurality of intersecting primitives 520. Once calculated, the surface equation may be used compute fractional occupancy and/or occlusion values for the voxel 510. Exemplary techniques for performing voxelization using surface equations are described below in further detail with respect to FIG. 9.

FIG. 9 is a flow diagram of method steps for performing voxelization using surface equations, according to one embodiment of the present invention. Although the method steps are described in conjunction with the systems of FIGS. 1-4, persons skilled in the art will understand that any system configured to perform the method steps, in any order, falls within the scope of the present invention.

As shown, a method 900 begins at step 910, where the geometry processing unit 425 determines that a voxel 510-2 is intersected by one or more primitives 520. At step 915, the geometry processing unit 425 selects a primitive 520-2 that intersects the voxel 510-2, as shown in FIGS. 8A and 8B. Next, at step 920, the fragment processing unit 460 calculates the coefficients of a plane defined by the intersection of the primitive 520-2 and the voxel 510-2. The coefficients of the intersecting plane 810 may be defined with respect to a reference point within the voxel 510-2. For example, coefficients for the intersecting plane 810 may be calculated with respect to a corner, an edge, or the center of the voxel 510-2.

After plane coefficients have been calculated, a determination is made at step 925 regarding whether coefficients were previously stored for the voxel 510-2. For example, coefficients may previously have been stored for the voxel 510-2 if one or more other primitives 520 intersect the voxel 510-2 and were previously analyzed. If no results have been stored for the voxel 510-2, then the coefficients calculated in step 920 are stored for the voxel 510-2 at step 930. If coefficients were previously stored for the voxel 510-2, then the raster operations unit 465 may combine the coefficients calculated in step 920 with the stored coefficients at step 935. For example, combining the coefficients may include computing average plane coefficients or computing a higher-order surface equation.

Accumulating plane equations to compute an average plane equation provides an accurate representation of the surface of the voxel 510-2 when most of the intersecting primitives 520 have roughly the same orientation. However, computing an average plane equation may provide a poor approximation of the underlying geometry when the intersecting primitives 520 have very different orientations. Accordingly, under such circumstances, a higher-order surface representation may be used. In one embodiment, instead of computing and storing an average plane equation, a quadric surface may be calculated using three or more coefficients. For example, a quadric surface may be stored using 10 coefficients of a 4×4 symmetric matrix. Advantageously, quadric matrices can be easily obtained from plane equations and linearly combined.

In addition to storing an average plane (or surface) equation, the fragment processing unit 460 may compute and store a curvature (e.g., an average curvature magnitude) for the voxel 510-2. For example, as the magnitude of curvature increases, the opacity for directions perpendicular to the plane direction may be increased during subsequent shading operations. A curvature magnitude may be computed and stored for each vertex of the voxel 510-2 and interpolated as a per pixel attribute.

At step 940, if another primitive 520 intersects the voxel 510-2, then the primitive 520 may be selected and analyzed beginning at step 915, previously described herein, and the raster operations unit 465 may combine the resulting coefficients with the stored coefficients at step 935.

Finally, at step 945, once surface coefficients are computed and stored for the voxel 510-2, the fragment processing unit 460 may use the coefficients to determine the amount (e.g., fraction) of the voxel 510-2 intersected by the primitive(s) 520 (i.e., the amount of the voxel 510-2 on the front side 635 or back side 630 of the primitive(s) 520) and/or the amount of the voxel occupied (i.e., fractional occupancy) by the geometric object(s) to which the primitive(s) 520 belong.

One technique for determining fractional occupancy is by performing a sphere-plane intersection. For example, the fragment processing unit 460 may calculate the radius of a sphere which intersects the average plane, where the radius of the sphere represents a distance from the average plane to a reference point in the voxel (e.g., the center of the voxel). A one-dimensional lookup may then be performed with the radius to estimate the fractional occupancy of the voxel 510-2. For example, the radius of the sphere may be calculated from the center of the voxel 510-2 to a surface of the average plane. This lookup table technique is computationally inexpensive and may compensate for cube-corner effects so that the estimated fractional occupancy changes gradually as a primitive 520 enters or exits the voxel 510-2. Additionally, multiple table lookup values can be interpolated (e.g., using linear interpolation) to more accurately estimate occupancy.

Another technique for determining fractional occupancy includes intersecting the average surface with the voxel 510-2 and computing the volume of the voxel 510-2 on the back side 630 of the average surface (e.g., the volume of the voxel 510-2 inside of the geometric object(s) to which the intersecting primitive(s) 520 belong). Alternatively, because determining the precise volume of the voxel 510-2 on the back side 630 of the average surface may be computationally expensive, a table lookup may be performed to determine fractional occupancy by first estimating the average surface with a low-precision plane.

The surface coefficients may further be used to compute occlusion values (e.g., directional occlusion, ambient occlusion, and the like). For example, the fragment processing unit 460 may compute directional occlusion values by clipping the average surface to the voxel 510-2 and projecting the clipped surface onto one or more planes. In one embodiment, the clipped surface may be projected along the three major axes onto three planes, and the resulting two-dimensional masks may be stored for the voxel 510-2. Directional occlusion then may be computed for a given vector by interpolating the two-dimensional masks according to the magnitude of the vector in each of the three major axes. Alternatively, directional occlusion may be estimated with other analytical techniques, by sampling in one or more directions, and/or by using a lookup table and a low-precision estimation of the average surface.

FIGS. 10A and 10B illustrate a technique for performing voxelization using scalar fields, according to one embodiment of the present invention. This voxelization technique may be performed by determining one or more scalar values for each primitive 520 that intersects the voxel 510-3. Each scalar value may be determined by measuring a distance between the surface of a primitive 520 and a reference point (e.g., sample point 1010-1, sample point 1010-2, and sample point 1010-3) within the voxel 510-3. The resulting scalar field then may be used to determine fractional occupancy and/or occlusion values for the voxel 510-3. For example, fractional occupancy and occlusion values may be determined by analyzing the magnitude and/or sign of one or more scalar values in a scalar field. Exemplary techniques for performing voxelization using scalar fields are described below in further detail with respect to FIG. 11.

FIG. 11 is a flow diagram of method steps for performing voxelization using scalar fields, according to one embodiment of the present invention. Although the method steps are described in conjunction with the systems of FIGS. 1-4, persons skilled in the art will understand that any system configured to perform the method steps, in any order, falls within the scope of the present invention.

As shown, a method 1100 begins at step 1110, where the geometry processing unit 425 determines that a voxel 510-3 is intersected by one or more primitives 520. At step 1115, the geometry processing unit 425 selects a primitive 520-3 that intersects the voxel 510-3, as shown in FIGS. 10A and 10B. At step 1120, one or more reference points (e.g., sample points 1010) are distributed within the voxel 510-3. Distributing sample points 1010 within the voxel 510-3 may include distributing sample points 1010 on one or more edges and/or corners (e.g., vertices) of the voxel 510-3 and/or at the center of the voxel 510-3. Although the sample points 1010 illustrated in FIGS. 10A and 10B are arranged in a regular lattice, any regular or irregular pattern or grid of sample points 1010 may be used.

Any number of sample points 1010 may be distributed within the voxel 510-3 based on, for example, a desired granularity, accuracy, processing workload, etc. In one embodiment, 8 sample points 1010 are distributed at the corners of the voxel 510-3. The scalar values stored for these sample points may or may not be shared (e.g., aggregated) between adjacent voxels 510. In another embodiment, a single sample point 1010 may be located at a corner of the voxel 510-3 or the center of the voxel 510-3. In another embodiment, for each selected primitive 520, only sample points 1010 located at the vertices of the voxel edge(s) intersected by a primitive 520 are analyzed.

Next, at step 1125, the fragment processing unit 460 calculates a distance between each sample point 1010 and a surface of the primitive 520-3. The location on the surface of the primitive 520-3 from which each distance is computed may represent the shortest distance between sample point 1010 and the primitive 520-3. Based on the distance between the sample point 1010 and the surface of the primitive 520-3, a scalar value may be determined at step 1130. The scalar value may be proportional (or equal) to the calculated distance. Additionally, the scalar value may be weighted based on an area of the primitive 520 intersected by the voxel 510-3 (e.g., the area of intersecting plane 1020). Further, a sign (i.e., positive or negative) may be assigned to each scalar value based on whether the corresponding sample point 1010 is on the front side 635 or back side 630 of the primitive 520-3. In the embodiment illustrated in FIGS. 10A and 10B, positive scalar values are stored for sample points 1010 determined to be on the front side 635 of a primitive 520 (e.g., sample point 1010-2), and negative scalar values are stored for sample points 1010 determined to be on the back side 630 of a primitive 520 (e.g., sample point 1010-1). Further, a zero value may be assigned to each sample point 1010 determined to be in a plane of the primitive 520 (e.g., sample point 1010-3).

Scalar values computed by analyzing multiple primitives 520 with respect to a single sample point 1010 may be aggregated by the raster operation unit 465. Scalar values may be aggregated using the area-based weighting assigned to each primitive 520, described above. In one embodiment, after one or more scalar values are computed for primitive 520, a determination is made at step 1135 regarding whether scalar values were previously stored for the one or more of the sample points 1010. For example, scalar values may previously have been stored for the sample point(s) 1010 if one or more other primitives 520 intersect the voxel 510-3 (or an adjacent voxel 510) and were previously analyzed. If no results have been stored for the sample points 1010, then the scalar value(s) determined in step 1130 may be stored at step 1140. If one or more scalar value(s) were previously stored for the sample point(s) 1010, then the scalar value(s) determined in step 1130 may be combined with the stored scalar value(s) at step 1145, for example, by summing the scalar values. At step 1150, if another primitive 520 intersects the voxel 510-3, then the primitive 520 may be selected and analyzed beginning at step 1115, and the determined scalar value(s) may be combined with the stored value(s) at step 1145. Prior to storing calculated scalar values, the scalar values associated with the voxel 510-3 may be initialized to a small positive (or negative) value (e.g., 1 e−7), such that empty voxels 510 do not appear to contain surfaces (e.g., intersecting primitives 520).

At step 1155, once a scalar field (e.g., including a signed scalar value for each sample point 1010) has been computed, the fragment processing unit 460 may use the scalar field to determine the fraction of the voxel 510-3 intersected by the primitive(s) 520 (i.e., the fraction of the voxel 510-3 on the front side 635 or back side 630 of the primitive(s) 520) and/or the fraction of the voxel 510-3 occupied (i.e., fractional occupancy) by the geometric object(s) to which the primitive(s) 520 belong. The fragment processing unit 460 may further use the scalar field to compute occlusion values (e.g., directional occlusion, ambient occlusion, and the like).

In one embodiment, fractional occupancy and occlusion values are determined for the voxel 510-3 using an implicit surface, line, point, etc. at which the scalar field is estimated to have a value of zero. The zero-value surface (or zero-value line) then may be measured, projected, etc. to determine fractional occupancy and occlusion, as discussed above with respect to the surface equation techniques of FIGS. 8A-9. For example, occlusion may be estimated by projecting the zero-value surface onto one or more planes. Additionally, a variety of other techniques, some of which may share characteristics of the techniques described above with respect to FIGS. 5-9, may be used to determine occupancy and occlusion with the scalar field, as described below.

In one technique, for each voxel 510, a table lookup is performed using the signs of the scalar values (e.g., the signs of scalar values assigned to sample points 1010 at the corners of the voxel 510) to estimate the surface of the voxel 510 with a low-precision plane. This technique may be compared to the marching cubes algorithm. Occupancy and occlusion then may be computed directly with one or more values retrieved from the lookup table without needing to compute the surface of the voxel 510.

In another technique, directional occlusion may be estimated along a primary axis by analyzing the scalar values located at the corners of a face of the voxel 510-3 that is perpendicular to the primary axis. One or more zero-value lines—along which the scalar values interpolate to zero—then may be calculated on the face using bilinear interpolation. The zero-value lines may be used to estimate the directional occlusion associated with the voxel. For example, a directional occlusion value may be determined by computing a ratio of the areas on either side of the zero-value line drawn on a face of the voxel 510-3. In yet another technique, the scalar values associated with a voxel 510 may be added, and the sum of the scalar values may be used to determine an occlusion value. For example, a zero sum may indicate that the occlusion is approximately 0.5 (or 50% occluded), a positive sum may indicate that the occlusion is less than 0.5, and a negative sum may indicate that the occlusion is more than 0.5. The magnitude of the sum may further indicate the degree to which the occlusion is above or below 0.5.

In still other embodiments, one scalar value may be determined for each voxel 510, and the scalar value may be mapped directly to the occupancy of the voxel 510. Mapping the scalar value to the occupancy of the voxel 510 may include clamping the scalar value (S) to [0, 1, 1-S]. For example, occupancy may be approximated by clamping the inverse of the scalar value 1-S to the range [0,1]. This technique may be useful when a single sample point 1010 is located at the center of the voxel 510.

Although the techniques depicted in FIGS. 6A-11 are described with respect to single voxels 510 (e.g., 510-1, 510-2, 510-3), each technique described above may be applied to construct volumetric representations of geometric objects (e.g., meshes of primitives 520) intersecting any number of voxels 510.

In sum, three techniques are disclosed for constructing a voxelized representation of a geometric object. The multi-sample anti-aliasing technique for performing voxelization distributes sample points within a voxel, determines which primitives intersect the voxel, and analyzes the intersecting primitives to determine whether each sample point is inside or outside of the geometric object. Intersecting primitives may be analyzed in three dimensions by iterating through all of the samples and evaluating each sample against one or more three-dimensional plane equations. Alternatively, sample point coverage of each intersecting primitive may be determined in two dimensions, followed by depth-testing the column of samples above and/or below each covered sample. The resulting voxel mask is then projected onto one or more reference planes to determine occlusion values, or the voxel mask is analyzed to determine a fraction of the voxel occupied by the geometric object.

Further, a technique for performing voxelization using surface equations calculates one or more surface coefficients (e.g., plane coefficients) for each primitive that intersects the voxel. Multiple sets of plane coefficients, corresponding to multiple intersecting primitives, are aggregated to calculate an average surface for the voxel 510-2. The average surface is estimated using a two-dimensional plane equation or using higher-order quadric surfaces. Fractional occupancy and/or occlusion values are then calculated with the average surface. Computing fractional occupancy may include performing sphere-plane intersections or performing table lookups using low-precision plane estimations. Additionally, multiple table look-up values can be interpolated (e.g., using linear interpolation) to more accurately estimate occupancy. Occlusion may be calculated by clipping the average surface to the voxel and projecting the clipped surface onto one or more reference planes.

Finally, a technique for performing voxelization using scalar fields determines a distance between each primitive and one or more reference points (e.g., sample points) distributed in the voxel. Samples points may be distributed, for example, at the corners of the voxel and/or a single sample point may be located at the center of each voxel. A signed scalar value is stored in a data array for each distance computed between a sample point and the primitive. Additionally, scalar values recorded for a given sample point are aggregated for multiple primitives that intersect the voxel. Fractional occupancy and/or occlusion are then determined by analyzing the sign(s) and magnitudes of the scalar values recorded for each sample point.

One advantage of the disclosed techniques is that a voxelized representation of a geometric object can be efficiently constructed and used to determine fractional occupancy and/or occlusion values. The determined occupancy and/or occlusion values then can be used to perform subsequent graphics operations or modeling computations without introducing as many artifacts and inaccuracies as conventional voxelization approaches. Further, the voxel masks, surface equations, and scalar fields described herein provide varying levels of accuracy, precision, and processing workload that can be selected and utilized to construct voxelized representations of geometric objects for a wide variety of applications.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed:

1. A method for performing voxelization, comprising:
identifying a voxel that is intersected by a first graphics primitive that has a front side and a back side;
selecting a plurality of sample points within the voxel;
determining, for each sample point included in the plurality of sample points, whether the sample point is located on the front side of the first graphics primitive or on the back side of the first graphics primitive; and
for at least a first sample point included in the plurality of sample points, storing a first result in a voxel mask reflecting whether the first sample point is located on the front side of the first graphics primitive or on the back side of the first graphics primitive.

2. The method of claim 1, wherein determining whether the sample point is located on the front side of the first graphics primitive or on the back side of the first graphics primitive comprises:
projecting the first graphics primitive onto a plane that is associated with a subset of sample points included in the plurality of sample points;
performing at least one coverage operation based on the projected first graphics primitive to determine one or more covered sample points included in the subset of sample points; and
for each covered sample point:
defining a column of sample points associated with the covered sample point; and
determining whether each sample point in the column of sample points is located on the front side of the first graphics primitive or on the back side of the first graphics primitive.

3. The method of claim 2, wherein the plane is perpendicular to a dominant axis of a normal associated with the first graphics primitive.

4. The method of claim 1, wherein determining whether the sample point is located on the front side of the first graphics primitive or on the back side of the first graphics primitive comprises evaluating the sample point against a plane equation defined by the intersection of the first graphics primitive with the voxel.

5. The method of claim 1, further comprising computing how much of the voxel is located on the back side of the first graphics primitive based on the voxel mask.

6. The method of claim 1, further comprising:
selecting one or more sample points that are located on the back side of the first graphics primitive;
projecting the one or more sample points onto a first plane to calculate a first two-dimensional mask;
projecting the one or more sample points onto a second plane to calculate a second two-dimensional mask; and
projecting the one or more sample points onto a third plane to calculate a third two-dimensional mask.

7. The method of claim 6, further comprising performing an interpolation operation based on two or more of the first two-dimensional mask, the second two-dimensional mask, and the third two-dimensional mask to compute a directional occlusion.

8. The method of claim 1, further comprising:
determining that the voxel is intersected by a second graphics primitive that has a front side and a back side;
selecting the plurality of sample points within the voxel;
determining, for each sample point included in the plurality of sample points, whether the sample point is located on the front side of the second graphics primitive or on the back side of the second graphics primitive; and
for at least the first sample point included in the plurality of sample points, storing a second result in the voxel mask reflecting whether the first sample point is located on the front side of the second graphics primitive or on the back side of the second graphics primitive.

9. The method of claim 8, wherein storing the second result in the voxel mask comprises:
reading the first result stored in the voxel mask, the first result and the second result associated with the first sample point;
generating a third result based on the first result and the second result; and storing the third result in the voxel mask, wherein the third result is associated with the first sample point.

20. A non-transitory computer-readable storage medium including instructions that, when executed by a processing unit, cause the processing unit to perform voxelization, by performing the steps of:
identifying a voxel that is intersected by a first graphics primitive that has a front side and a back side;
selecting a plurality of sample points within the voxel;
determining, for each sample point included in the plurality of sample points, whether the sample point is located on the front side of the first graphics primitive or on the back side of the first graphics primitive; and
for at least a first sample point included in the plurality of sample points, storing a first result in a voxel mask reflecting whether the first sample point is located on the front side of the first graphics primitive or on the back side of the first graphics primitive.

11. The non-transitory computer-readable storage medium of claim 10, wherein determining whether the sample point is located on the front side of the first graphics primitive or on the back side of the first graphics primitive comprises:
projecting the first graphics primitive onto a plane that is associated with a subset of sample points included in the plurality of sample points;
performing at least one coverage operation based on the projected first graphics primitive to determine one or more covered sample points included in the subset of sample points; and
for each covered sample point:
defining a column of sample points associated with the covered sample point; and
determining whether each sample point in the column of sample points is located on the front side of the first graphics primitive or on the back side of the first graphics primitive.

12. The non-transitory computer-readable storage medium of claim 11, wherein the plane is perpendicular to a dominant axis of a normal associated with the first graphics primitive.

13. The non-transitory computer-readable storage medium of claim 10, wherein determining whether the sample point is located on the front side of the first graphics primitive or on the back side of the first graphics primitive comprises evaluating the sample point against a plane equation defined by the intersection of the first graphics primitive with the voxel.

14. The non-transitory computer-readable storage medium of claim 10, further comprising computing how much of the voxel is located on the back side of the first graphics primitive based on the voxel mask.

15. The non-transitory computer-readable storage medium of claim 10, further comprising:
selecting one or more sample points that are located on the back side of the first graphics primitive;
projecting the one or more sample points onto a first plane to calculate a first two-dimensional mask;
projecting the one or more sample points onto a second plane to calculate a second two-dimensional mask; and
projecting the one or more sample points onto a third plane to calculate a third two-dimensional mask.

16. The non-transitory computer-readable storage medium of claim 15, further comprising performing an interpolation operation based on two or more of the first two-dimensional mask, the second two-dimensional mask, and the third two-dimensional mask to compute a directional occlusion.

17. The non-transitory computer-readable storage medium of claim 10, further comprising:
determining that the voxel is intersected by a second graphics primitive that has a front side and a back side;
selecting the plurality of sample points within the voxel;
determining, for each sample point included in the plurality of sample points, whether the sample point is located on the front side of the second graphics primitive or on the back side of the second graphics primitive; and
for at least the first sample point included in the plurality of sample points, storing a second result in the voxel mask reflecting whether the first sample point is located on the front side of the second graphics primitive or on the back side of the second graphics primitive.

18. The non-transitory computer-readable storage medium of claim 17, wherein storing the second result in the voxel mask comprises:
reading the first result stored in the voxel mask, the first result and the second result associated with the first sample point;
generating a third result based on the first result and the second result; and storing the third result in the voxel mask, wherein the third result is associated with the first sample point.

19. A computing device, comprising:
a memory; and
a graphic processing pipeline coupled to the memory and configured to perform voxelization by:
identifying a voxel that is intersected by a first graphics primitive that has a front side and a back side;
selecting a plurality of sample points within the voxel;
determining, for each sample point included in the plurality of sample points, whether the sample point is located on the front side of the first graphics primitive or on the back side of the first graphics primitive; and
for at least a first sample point included in the plurality of sample points, storing a first result in a voxel mask reflecting whether the first sample point is located on the front side of the first graphics primitive or on the back side of the first graphics primitive.

20. The computing device of claim 19, wherein the graphic processing pipeline is configured to determine whether the sample point is located on the front side of the first graphics primitive or on the back side of the first graphics primitive by:
projecting the first graphics primitive onto a plane that is associated with a subset of sample points included in the plurality of sample points;
performing at least one coverage operation based on the projected first graphics primitive to determine one or more covered sample points included in the subset of sample points; and
for each covered sample point:
defining a column of sample points associated with the covered sample point; and
determining whether each sample point in the column of sample points is located on the front side of the first graphics primitive or on the back side of the first graphics primitive.
